(19) United States
(12) Patent Application Publication
(10) Pub. No.: US 2009/0048992 A1
(43) Pub. Date: Feb. 19, 2009

(54) SYSTEM AND METHOD FOR REDUCING THE REPETITIVE RECEPTION OF A MEDIA ITEM RECOMMENDATION

(75) Inventors: Hugh Svendsen, Chapel Hill, NC (US); Eugene Matthew Farrelly, Cary, NC (US); Gary W. Black, Cary, NC (US)

Correspondence Address: CONCERT TECHNOLOGY AND WITHROW & TERRANOVA, 100 REGENCY FOREST DRIVE , SUITE 160, CARY, NC, 27518, US

(73) Assignee: CONCERT TECHNOLOGY CORPORATION, Durham, NC (US)

(21) Appl. No.: 11/837,846

(22) Filed: Aug. 13, 2007

(51) Int. Cl. G06F 15/18

(52) U.S. Cl. 706/14

(57) ABSTRACT

A system and method for reducing the repetitive reception of a media item recommendation in a media item recommendation system are disclosed. A media item recommendation is received from a recommender. The media item recommendation is designated to be sent to an intended recipient. Before the media item recommendation is sent to the intended recipient, a record of activity of the media item is reviewed and a determination is made as to whether to send the media item recommendation to the intended recipient based on the record of activity. In this manner, it can be determined if the media item recommendation is unduly repetitive and, if so, not sent to the intended recipient. This reduces the continuous feed-back loop of the same media item recommendation.

### RELATED APPLICATIONS

The present application is related to commonly assigned U.S. patent application Ser. No. ______, filed Aug. 13, 2007, entitled “SYSTEM AND METHOD FOR REDUCING THE MULTIPLE LISTING OF A MEDIA ITEM IN A PLAYLIST,” which is hereby incorporated herein by reference in its entirety.

### FIELD OF THE INVENTION

The present invention relates to a system and method for reducing the repetitive reception of a media item recommendation in a media item recommendation system.

### BACKGROUND OF THE INVENTION

In recent years, there has been an enormous increase in the amount of digital media available online. Services, such as Apple's iTunes® for example, enable users to legally purchase and download music. Other services, such as Yahoo!® Music Unlimited and RealNetwork's Rhapsody® for example, provide access to millions of songs for a monthly subscription fee. YouTube® provides users access to video media. As a result, media items have become much more accessible to consumers worldwide. Due to the large amount of accessible digital media, recommendation technologies have emerged as an important enabler to assist users in identifying and navigating large databases of available media. Recommendations are useful to help users identify and select media items of interest for usage and/or play.

Recommendations may be programmatically-generated by a company based on the user's predefined preferences and/or profile. Recommendations also may be provided by other users. Particularly, the users may be peers on a social network. As such, a user on the social network may be both a recommender and a recipient of a media item recommendation. Moreover, applications exist that provide for the automatic generation and transmission of media item recommendations on a social network based on the occurrence of certain triggering events, such as the user playing the media item, for example. As such, a recommender may explicitly provide a recommendation to a recipient by sending the recommendation, or the recommender may implicitly provide a recommendation to a recipient by playing the media item.

In the latter case, when a first user plays a media item, the first user automatically becomes a recommender. A media item recommendation for the media item may be generated and sent to a second user acting as the recipient. The second user may be in a list of the first user's “friends” designated to receive media item recommendations from the first user. If the second user also plays the media item, then another media item recommendation for the same media item may be generated and transmitted back to the first user if the first user is in the list of “friends” of the second user. In this case, the second user becomes the recommender and the first user becomes the recipient. This type of automatic generation and transmission of media item recommendations may create a “ping-ponging” effect between users in the social network causing the users to oscillate between being recommenders and recipients of media item recommendations for the same media item. This may result in a continuous feed-back loop of the same media item recommendation.

This “ping-ponging” effect may be exacerbated if the media item is highly desirable resulting in the frequent playing of the media item by users in the media item recommendation system. This is especially problematic if the media item recommendation application is programmed to automatically selectively play a media item based on its rating. The higher the rating of the media item, the more often the media item may be played. To compound this problem, the rating may be based on how often the media item is played and/or recommended. Therefore, the more a media item is played, the more often a media item recommendation may be generated and transmitted to the users, particularly previous recommenders, and the higher the rating becomes. While there may be reasons for receiving repetitive media item recommendations, such as to communicate updated media item preferences among the users for example, the continuous reception of repetitive media item recommendations may result in the media item being played more than intended and appropriate, and as a result, artificially elevate the rating of the media item for an extended period inconsistent with its true popularity at a given time.

Accordingly, a need exists for a method and system for reducing the repetitive reception by a recipient of a media item recommendation for a media item.

### SUMMARY OF THE INVENTION

The present invention is directed to a system and method for reducing the repetitive reception of a media item recommendation in a media item recommendation system. A media item recommendation is received from a recommender. The media item recommendation is designated to be sent to an intended recipient. Before the media item recommendation is sent to the intended recipient, a record of activity of the media item is reviewed and a determination is made as to whether to send the media item recommendation to the intended recipient based on the record of activity. In this manner, it can be determined if the media item recommendation is unduly repetitive and, if so, not sent to the intended recipient. This reduces the continuous feed-back loop of the same media item recommendation.

The record of activity may comprise a play history of the recipient and/or a record of recommendations of the media item. More particularly, in one embodiment, the determination whether to send the media item recommendation to the intended recipient may be based on whether the record of activity includes a recommendation withholding activity. If the record of activity does not include a recommendation withholding activity, the media item recommendation is sent to the recipient. If the record of activity includes a recommendation withholding activity, the media item recommendation is not sent to the recipient.

The recommendation withholding activity may include the recipient playing the media item. This recommendation withholding activity may be conditioned on whether the recipient played a certain number of other media items since playing the media item. Or, the recommendation withholding activity may be conditioned on whether a certain time has elapsed since the media item was last played by the recipient.

Alternatively or additionally, the recommendation withholding activity may include the recipient recommending the media item. In such a case, the recipient may have recommended the media item to the recommender and/or to other users, and the media item recommendation is essentially returning to the recipient in a loop. This recommendation withholding activity may be conditioned on whether the recipient recommended a certain number of other media items since recommending the media item. Or, the recommendation withholding activity may be conditioned on whether a certain time has elapsed since the recipient recommended the media item.

Alternatively or additionally, the recommendation withholding activity may include the recipient receiving a recommendation for the media item from the recommender or another user. This recommendation withholding activity may be conditioned on the number of other recommendations received by the recipient since receiving a recommendation for the media item. Or, the recommendation withholding activity may be conditioned on whether a certain time has elapsed since the recipient received the recommendation for the media item.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates an exemplary user-server media item recommendation system, wherein the repetitive reception of a media item recommendation is reduced according to one embodiment of the present invention;

FIG. 2 is a block diagram illustrating an exemplary user device of FIG. 1;

FIG. 3 is a block diagram illustrating an exemplary media item recommendation message;

FIG. 4 is a flow chart illustrating a process for receiving a media item recommendation, and determining whether to send the media item recommendation to a recipient according to one embodiment of the present invention;

FIGS. 5, 6, and 7 are block diagrams illustrating the components of an exemplary play history in user accounts of three users, ‘A’, ‘B,’ and ‘N,’ in the media item recommendation system of FIG. 1, wherein the play history stores a record of media items played by the user according to one embodiment of the present invention;

FIG. 8 is a block diagram illustrating an example of a record of recommendations of a media item in the form of a recommendation path table, wherein the recommendation path table stores a record of the recommendations of the media item according to one embodiment of the present invention;

FIG. 9 illustrates an exemplary graphical user interface (GUI) for providing recommendation withholding activity information based on playing a media item according to one embodiment of the present invention;

FIG. 10 illustrates an exemplary graphical user interface (GUI) for providing recommendation withholding activity information based on an outgoing media item recommendation according to one embodiment of the present invention;

FIG. 11 illustrates an exemplary graphical user interface (GUI) for providing recommendation withholding activity information based on an incoming media item recommendation according to one embodiment of the present invention;

FIGS. 12A, 12B, and 12C illustrate exemplary communication flow diagrams between a central server and user devices, wherein a media item recommendation message is received by the central server and a determination is made whether to send the media item recommendation to a user device based on the existence of a recommendation withholding activity according to one embodiment of the present invention;

FIG. 13 is a flow chart illustrating the process for receiving a media item recommendation, determining whether a recommended media item is currently listed in a playlist, and merging information in the media item recommendation with information listed in the playlist according to one embodiment of the present invention;

FIG. 14 is a block diagram illustrating components of an exemplary media item playlist, wherein media item recommendations and associated information are merged with information of a media item currently listed in the playlist;

FIG. 15 illustrates an exemplary graphical user interface (GUI) for selecting an algorithm for computing a merged score from a recommendation score determined from a media item recommendation according to one embodiment of the present invention;

FIG. 16 is a block diagram illustrating more detail regarding components on the central server of FIG. 1 according to one embodiment of the present invention; and

FIG. 17 is a block diagram illustrating more detail regarding components in the user device of FIG. 2 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present application is related to commonly assigned U.S. patent application Ser. No. ______, filed Aug. 13, 2007, entitled “SYSTEM AND METHOD FOR REDUCING THE MULTIPLE LISTING OF A MEDIA ITEM IN A PLAYLIST,” which is hereby incorporated herein by reference in its entirety.

The present invention is directed to a system and method for reducing the repetitive reception of a media item recommendation in a media item recommendation system. A media item recommendation is received from a recommender. The media item recommendation is designated to be sent to an intended recipient. Before the media item recommendation is sent to the intended recipient, a record of activity of the media item is reviewed and a determination is made as to whether to send the media item recommendation to the intended recipient based on the record of activity. In this manner, it can be determined if the media item recommendation is unduly repetitive and, if so, not sent to the intended recipient. This reduces the continuous feed-back loop of the same media item recommendation.

The record of activity may comprise a play history of the recipient and/or a record of recommendations of the media item. More particularly, in one embodiment, the determination whether to send the media item recommendation to the intended recipient may be based on whether the record of activity includes a recommendation withholding activity. If the record of activity does not include a recommendation withholding activity, the media item recommendation is sent to the recipient. If the record of activity includes a recommendation withholding activity, the media item recommendation is not sent to the recipient.

The recommendation withholding activity may include the recipient playing the media item. This recommendation withholding activity may be conditioned on whether the recipient played a certain number of other media items since playing the media item. Or, the recommendation withholding activity may be conditioned on whether a certain time has elapsed since the media item was last played by the recipient.

Alternatively or additionally, the recommendation withholding activity may include the recipient recommending the media item. In such a case, the recipient may have recommended the media item to the recommender and/or to other users, and the media item recommendation is essentially returning to the recipient in a loop. This recommendation withholding activity may be conditioned on whether the recipient recommended a certain number of other media items since recommending the media item. Or, the recommendation withholding activity may be conditioned on whether a certain time has elapsed since the recipient recommended the media item.

Alternatively or additionally, the recommendation withholding activity may include the recipient receiving a recommendation for the media item from the recommender or another user. This recommendation withholding activity may be conditioned on the number of other recommendations received by the recipient since receiving a recommendation for the media item. Or, the recommendation withholding activity may be conditioned on whether a certain time has elapsed since the recipient received the recommendation for the media item.

The user in the media item recommendation system may be a recommender, a recipient, or both. For purposes of the present invention, when describing a user that transmits a media item recommendation message, the term “recommender” may be used. When describing a user that receives a media item recommendation message, the term “recipient” may be used.

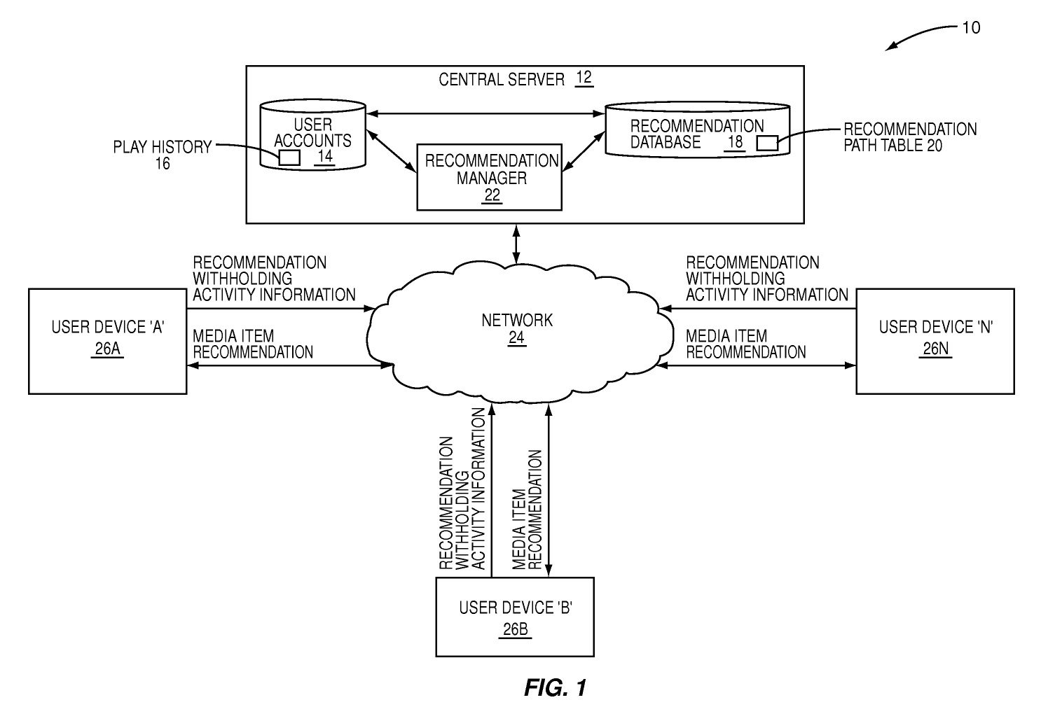

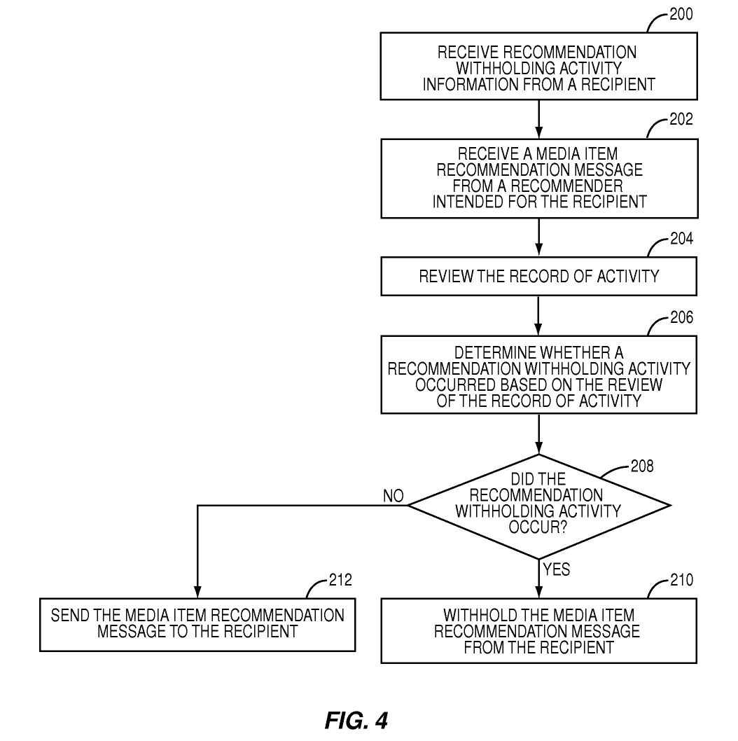

As backdrop for the present invention, FIGS. 1-3 illustrate an exemplary media item recommendation system that includes user devices and a media item recommendation message structure transmitted over the media item recommendation system. Before discussing examples of how the repetitive reception of the media item recommendation for a media item may be reduced, FIGS. 1-3 will be discussed to provide a brief overview of the media item recommendation system, the server and devices, and the media item recommendation message structure. The discussion of how the media item recommendation system reduces the repetitive reception of the media item recommendation for a media item begins with FIG. 4.

Turning to FIG. 1, a media item recommendation system 10 is provided having a central server 12 that manages the flow of information and services provided to users in the media item recommendation system 10. The central server 12 may be comprised of a database of user accounts 14, which may include a play history 16, a recommendation database 18, which may include a recommendation path table 20, and a recommendation manager 22. The central server 12 is able to communicate with other devices and systems over a network 24. The network 24 may be any private network or public network such as, but not limited to, the Internet, or a combination of both and may take any medium form, including, but not limited to, wired or wireless.

The user accounts 14 contain a record of accounts for each user known to the central server 12 and information concerning aspects of the user's activities in the media item recommendation system 10. In addition to the play history 16, which stores a record of the media item play activity of the user, the information in the user accounts 14 may include user profiles, preferences, and other information about the user and the user's media collection. The recommendation database 18 stores a record of each media item recommendation that is provided on the media item recommendation system 10. The media item recommendation may be recorded in the recommendation path table 20. The recommendation manager 22 is a program, algorithm, or control mechanism that interacts with the user accounts 14 and the recommendation database 18 to manage and control the sending of the media item recommendation to the recipient. The recommendation manager 22 may store recommendation withholding activity information provided by the user and may review the record of activity of the media item being recommended to determine if a media item recommendation received from a recommender is to be sent to a recipient.

The media item recommendation system 10 also includes a number of user devices 26A-26N which may communicate with the central server 12 and each other via the network 24. Note that while three user devices 26A, 26B, 26N are illustrated, the present invention may be used with any number of user devices 26. In the particular example of FIG. 1, the central server 12 operates in a user-server relationship with the users. However, it should be noted that the present invention may be implemented in a peer-to-peer configuration where features of the central server 12 are provided by a “super” user device 26. Note that the central server 12 may also be implemented as a number of servers operating in a collaborative fashion. The central server 12, in whatever form provided, provides and/or facilitates media-based services to the user. An example of a media item recommendation system that may be implemented in a user-server or peer-to-peer configuration is described in co-pending U.S. patent application Ser. No. 11/484,130, entitled “P2P NETWORK FOR PROVIDING REAL TIME MEDIA RECOMMENDATIONS,” filed Jul. 11, 2006, which is hereby incorporated herein by reference in its entirety.

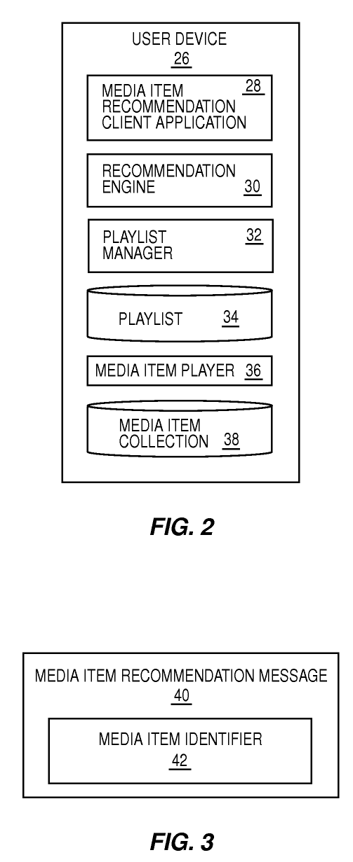

FIG. 2 illustrates an exemplary user device 26, the components that may be included in the user device 26, and provides a structure for discussing the interaction of the components among themselves, with other user devices 26, and with the central server 12 (FIG. 1).

The user device 26 may be any type of computing device that is capable of performing communications over the network 24 (FIG. 1) to reach the central server 12 and other user devices 26. The user device 26 may also include a user interface, which may include components such as a display, speakers, a user input device, and the like. Examples of user devices 26 include, but are not limited to: home computers; computers at work; laptop computers; wireless portable media player (PMP) devices; hand-held computer devices, such as personal digital assistants (PDAs) with remote communication capabilities; cell phones; and the like. Each user who desires to access and receive the services of the central server 12 first establishes a user account 14 with the central server 12. The user may then interact with the central server 12 and other users through the user device 26. This allows the user device 26 to receive and download a media item recommendation client application 28, which provides a customized software interface to the central server 12. After the media item recommendation client application 28 is downloaded onto the user device 26, the media item recommendation client application 28 executes on the user device 26.

The user device 26 may also contain a recommendation engine 30. The recommendation engine 30 is a program, algorithm, or control mechanism that handles sending and/or receiving media item recommendations over the network 24. The recommendation engine 30 may also score media items and/or media item recommendations based on user preferences for the different media categories, for example genre, artist, title, album, lyrics, date of release, or the like, and then filters media item recommendations from the other user devices 26 based on such preferences.

The user device 26 typically contains a playlist manager 32, a playlist 34, and a media item player 36. The playlist manager 32 is a program, algorithm, or control mechanism that controls the storing of media item recommendation information in the playlist 34 and the downloading and rendering or playing of the media items listed in the playlist 34. The media item player 36 allows the user to use or play back any media item desired. Examples of media item players 36 include, but are not limited to, Apple® iTunes®, Apple® iPOD®, and the like. The media items selected for use and/or play include those stored locally at the user device 26 in a user's media item collection 38 and/or any media item accessed from the central server 12, another user device 26, subscription service(s) (not shown), and/or any other system accessible by or coupled to the network 24.

FIG. 3 is a block diagram illustrating an exemplary media item recommendation message 40 and is provided to show that a media item recommendation may be sent and received in the media item recommendation system 10 in a structured message format that comprises a media item identifier 42, which is used by the media item recommendation system 10 to identify the specific media item being recommended. The media item identifier 42 may be any type or form of unique identifier, such as an alphanumeric format or progression comprising and/or referring to a known fingerprint and/or Globally Unique Identifier (GUID) of the media item, for example. Additionally, other information including, but not limited to, the identity of the recommender, the recommendation score, and the time the media item recommendation message 40 was sent may be included in the media item recommendation message 40.

FIG. 4 is a flow chart illustrating the process for reducing the repetitive reception of a media item recommendation according to one embodiment of the present invention. In this embodiment, the process may be performed by the central server 12. However, it should be understood that other devices and/or components of the media item recommendation system 10 may perform such processes. Accordingly, the present invention is not limited to the central server 12 performing the process illustrated and described in FIG. 4. A media item recommendation message 40 is received from a recommender intended for a recipient. A determination is made based on a record of activity whether to send the media item recommendation message 40 to the recipient.

The process begins when the central server 12 receives recommendation withholding activity information from a recipient (step 200). The recipient may provide the recommendation withholding activity information to specify the activities that, if previously occurring, would keep the media item recommendation message 40 (FIG. 3) from being sent to the recipient. In other words, the recommendation withholding activity information provides a direction from the recipient to the central server 12 for the central server 12 to withhold sending the media item recommendation message 40 to the recipient if the recommendation withholding activity occurred.

The central server 12 then receives a media item recommendation message 40 from a recommender intended for the recipient (step 202). A record of activity of the media item is reviewed (step 204). The record of activity may include the intended recipient's play history 16 and/or the media item's record of recommendation, which may be in the recommendation path table 20.

The purpose for reviewing the record of activity is to determine whether a recommendation withholding activity occurred (step 206). A decision may then be made based on whether the recommendation withholding activity occurred (step 208). If the recommendation withholding activity occurred, the media item recommendation message 40 may be withheld from the recipient (step 210). If the recommendation withholding activity did not occur, the media item recommendation message 40 may be sent to the recipient (step 212).

The recommendation manager 22 (FIG. 1) may perform steps 204 through 206. As such, the recommendation manager 22 may store the recommendation withholding activity information received from the recipient in step 200. Upon the central server 12 receiving the media item recommendation message 40, the recommendation manager 22 reviews the record of activity to determine if the recommendation withholding activity occurred, and determines whether the central server 12 sends the media item recommendation message 40 to, or withholds the media item recommendation message 40 from, the recipient.

The recommendation withholding activity may be directed to the recipient's activity involving the media item and may identify one or more criteria and/or conditions applying to the recipient's activity. For example, the recipient may not want to receive a recommendation for the media item if the recipient previously played the media item, recommended the media item, and/or received a recommendation for the media item. As such, the central server 12 will withhold from the recipient, or, in other words, not send the media item recommendation message 40 to the recipient if the recommendation withholding activity occurred. Further, the recipient may not want the central server 12 to withhold all such media item recommendations but may condition the withholding of the media item recommendation. For example, the condition may be that the recipient played the media item within a certain time period or within a certain number of other media items played. In such a case, the recipient may direct the central server 12 to withhold the media item recommendation message 40 if the recipient, for example, played less than sixty other media items since playing the media item, or that less than ninety minutes has elapsed since the recipient played the media item.

As another example, the recipient may direct the central server 12 to withhold the media item recommendation message 40 based on the number of recommendations of other media items the recipient has sent or received since the last time the recipient sent or received a recommendation for the media item. Alternatively, the recommendation withholding activity may be conditioned on the time that has elapsed since the recipient has sent or received a recommendation for the media item. The above examples should not be understood to limit the present invention in any manner.

Additionally, although not shown in FIG. 4, the central server 12 may determine whether the media item recommendation message 40 is explicit or implicit. At the completion of a user playing the media item using the user device 26, the user device 26 typically automatically generates and sends the media item recommendation message 40 to the central server 12. In such a case, the media item recommendation message 40 may be identified as implicit, because the media item recommendation message 40 resulted from the user playing the media item, or some other action, other than the user deciding to explicitly direct the user device 26 to send the media item recommendation message 40 to the recipient.

However, the user may decide to send a media item recommendation message 40 to the recipient without, or at least not at the same time as, playing the media item. In such a case, the media item recommendation message 40 may be identified as explicit. The central server 12 may send such explicit media item recommendation messages 40 to the recipient without reviewing the record of activity to determine if a recommendation withholding activity had occurred.

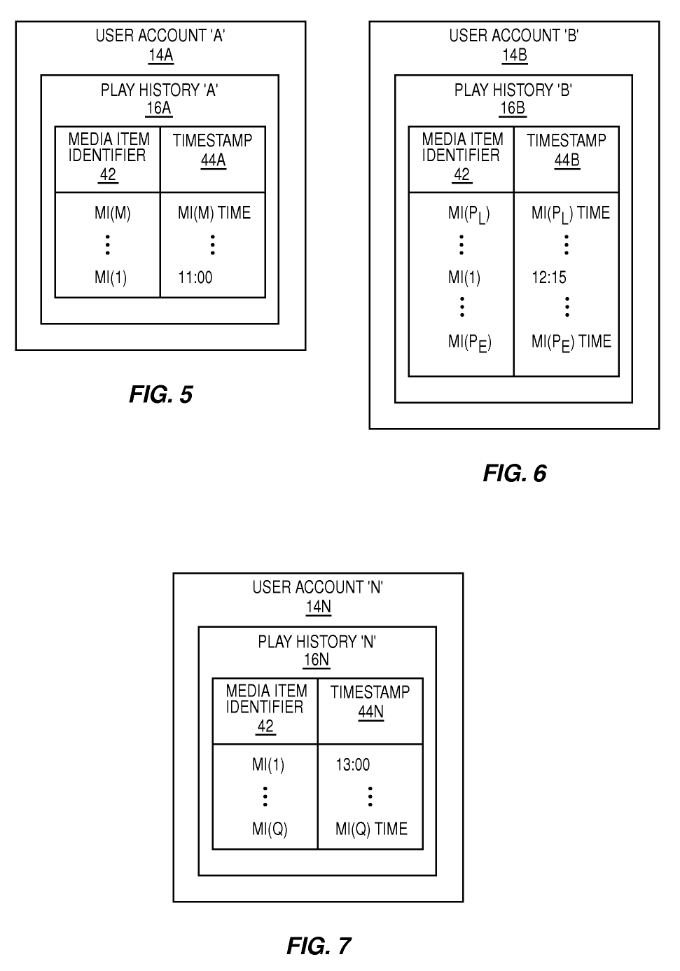

FIGS. 5-7 are block diagrams illustrating a play history 16A of the user ‘A,’ a play history 16B of the user ‘B,’ and a play history 16N of the user ‘N,’ respectively, according to one embodiment of the present invention. FIGS. 5-7 are provided to illustrate the recording of the play activity of the users ‘A,’ ‘B,’ and ‘N’ of a media item (1), which is designated with the media item identifier 42 ‘MI(1).’ FIGS. 5-7 show how the recommendation withholding activity may be included in the play histories 16 of intended recipients of the media item recommendation message 40.

In addition to the media item identifier 42, the play history 16 also comprises a ‘TIMESTAMP’ 44 column which lists a record of the time that the media item was played by the user device 26. The play histories 16 list the media items played in reverse chronological order, with the most recently played media item listed first, or at the top, and the other media items listed in descending order according to their play time. For purposes of explaining this embodiment of the present invention, FIGS. 5-7 may be viewed as illustrating the play history 16A, the play history 16B, and the play history 16N, respectively, at the same point in time.

The play history 16A in FIG. 5 shows that the user device 26A played the media item (1) first. The ‘TIMESTAMP’ 44A column in the play history 16A indicates that the user device 26A played a total of ‘M’ media items with media item (1) played at 11:00 AM. Upon playing the media item (1), the user device 26A may have generated and sent a media item (1) recommendation message 40A, which the user device 26B and the user device 26N may have received.

FIG. 6 shows that the user device 26B played the media item (1) next. The ‘TIMESTAMP’ 44B column in the play history 16B indicates that the user device 26B played a total of ‘P’ media items with media item (1) played at 12:15 PM. The play history 16B shows the media item identifier 42 ‘MI(1)’ in the middle of the media items played by the user device 26B between the earliest media item played ‘MI(P_{E})’ and the most recent media item played ‘MI(P_{L}).’ Similar to the discussion of the play history 16A above, the play history 16B shows that the user device 26B may have generated and sent a media item (1) recommendation message 40B. However, it cannot be determined from FIGS. 5-7 whether the media item (1) recommendation message 40B from user device 26B was received by the user device 26A and/or the user device 26N.

FIG. 7 shows that the user device 26N most recently played the media item (1) with the media item identifier 42 ‘MI(1)’ first on the list in the play history 16N. The ‘TIMESTAMP’ 44N column in the play history 16N indicates that the user device 26N played a total of ‘Q’ media items with media item (1) played at 13:00, or 1:00 PM. Again, as discussed above, the play history 16N shows that the user device 26N may have generated and sent a media item (1) recommendation message 40N, but it cannot be determined from FIGS. 5-7 whether the user device 26A and/or the user device 26B received the media item (1) recommendation message 40N from the user device 26N.

FIG. 8 is a block diagram illustrating the components of an exemplary recommendation path table 20 in a recommendation database 18 according to one embodiment of the present invention. A media item (1) recommendation path table 20 is provided to show a record of recommendations for the media item (1) received from and sent to the user devices 26. FIG. 8 illustrates how the sending of the media item (1) recommendation message 40 to the user devices 26 may be affected by the recommendation withholding activity to avoid the repetitive reception by the user device 26 of the media item (1) recommendation message 40. As such, the media item (1) recommendation path table 20 provides a record of the media item (1) recommendation message 40 being received and sent, the user devices 26 sending and receiving the media item (1) recommendation message 40, and the timing thereof.

The information as recorded in the media item (1) recommendation table 20 includes information that may not be available by reviewing only the play histories 16. For example, the recommendation withholding activity may be based on the timing of the playing of the media item by a user device 26. As such, the information in the play histories 16, as shown in FIGS. 5-7, and the information in the media item (1) recommendation path table, as shown in FIG. 8, may be used in combination to determine whether the playing of media item (1) by one of the user devices 26 affects the sending of the media item (1) recommendation message 40 to one of the other user devices 26 based on the recommendation withholding activity.

Accordingly, for purposes of discussing this embodiment of the present invention, the time of the receipt of each media item (1) recommendation message 40 from the respective user devices 26A, 26B, 26N is shown as the same time as the respective user devices 26A, 26B, 26N played the media item (1), as shown in FIGS. 5-7. Although not shown in FIG. 8, there may be a time differential between the receipt of the media item (1) recommendation message 40 from the user device 26 and the sending of the media item (1) recommendation message 40 to the different user devices 26. The time differential may be necessary for the central server 12 to perform certain functions, including the processes and functions described in the embodiment of the present invention.

The media item (1) recommendation path table 20 in FIG. 8 may include a recommendation path identifier 46, the media item identifier 42 “MI(1),” a recommender identifier 48, recipient identifiers 50, and a ‘TIMESTAMP’ 44. A unique recommendation path identifier 46 is generated for each initial recommendation of the media item (1), and is copied to any follow-on recommendations that ultimately derive from such initial recommendation. Thus, the same recommendation path identifiers 46 in the media item (1) recommendation path table 20 form a series of recommendations for media item (1). As such, media item (1) may have multiple series of recommendations.

The recommendation path identifier 46 may be any unique identifier. In FIG. 8, the recommendation path identifier 46 is shown as a combination of the media item and the initial recommender. Accordingly, two media item paths are shown by the recommendation path identifiers 46 “1A” and “1C.” The recommendation path identifier 46 “1A” designates a media item path for media item (1) initiated by the user device 26A, and the recommendation path identifier 46 “1C” designates a separate media item path for media item (1) initiated by the user device 26C.

The oldest, or least recent, recommendation is shown as being from the user device 26A. The user device 26A initially recommended the media item (1) and, accordingly, the media item (1) recommendation message 40A from the user device 26A was sent to the user device 26B and the user device 26N at 11:00. This is indicated by “1A” as the recommendation path identifier 46, “A” as the recommender identifier 48, “B” and “N” as the recipient identifiers 50, and 11:00 as the ‘TIMESTAMP’ 44 at the bottom of the media item (1) recommendation path table 20.

The next oldest, or least recent, recommendation is shown as being from the user device 26B as a follow-on recommendation in the series initiated by the user device 26A. The media item (1) recommendation message 40B from the user device 26B was then sent to the user device 26N at 12:15. This is indicated by “1A” as the recommendation path identifier 46, “B” as the recommender identifier 48, “N” as the recipient identifier 50, and 12:15 as the ‘TIMESTAMP’ 44.

Notably, the media item (1) recommendation path table 20 does not indicate that the media item (1) recommendation message 40B from the user device 26B was sent to the user device 26A. This may reflect the recommendation withholding activity information provided by the user device 26A to the central server 12. For example, and as discussed above with respect to FIG. 4, the user of the user device 26A may have directed the central server 12 to withhold the media item (1) recommendation message 40 if the recipient played the media item (1) within the last ninety minutes. Because the ‘TIMESTAMP’ 44 for the media item (1) recommendation message 40B from the user device 26B, 12:15, is less than ninety minutes from the ‘TIMESTAMP’ 44A identifying the last time the user device 26A played the media item (1), 11:00, as shown in FIG. 5, the central server 12 withheld the media item (1) recommendation message 40B from the user device 26A.

The next oldest, or least recent, recommendation is shown as being from the user device 26C. The media item (1) recommendation message 40C was sent to the user device 26D at 12:30. As discussed above, the recommendation from the user device 26C is a separate recommendation path and not a follow-on recommendation in the series initiated by the user device 26A. This is indicated by “1C” as the recommendation path identifier 46, “C” as the recommender identifier 48, “D” as the recipient identifier 50, and 12:30 as the ‘TIMESTAMP’ 44.

The youngest, or most recent, recommendation is shown as being from the user device 26N as a follow-on recommendation in the series initiated by the user device 26A. The media item (1) recommendation message 40N from the user device 26N was then sent to the user device 26A at 13:00. This is indicated by “1A” as the recommendation path identifier 46, “N” as the recommender identifier 48, “A” as the recipient identifier 50, and 13:00 as the ‘TIMESTAMP’ 44.

Notably, FIG. 8 shows that the media item (1) recommendation message 40N from the user device 26N was sent to the user device 26A. Because the ‘TIMESTAMP’ 44 for the media item (1) recommendation message 40N from the user device 26N, 13:00, is more than ninety minutes from the ‘TIMESTAMP’ 44A identifying the last time the user device 26A played the media item, 11:00, as shown in FIG. 5, the central server 12 sent the media item (1) recommendation message 40N to the user device 26A.

Conversely, the central server 12 withheld the media item (1) recommendation message 40N from the user device 26B. As with the user device 26A, the user of the user device 26B may have directed the central server 12 to withhold the media item (1) recommendation message 40 if the time of the media item (1) recommendation message 40 is within ninety minutes of the user device 26B playing the media item (1). Because the ‘TIMESTAMP’ 44 for the media item (1) recommendation message 40N, 13:00, is less than ninety minutes from the ‘TIMESTAMP’ 44B identifying the last time the user device 26B played the media item (1), 12:15, as shown in FIG. 6, the central server 12 withheld the media item (1) recommendation message 40N from the user device 26B.

Although in this embodiment the media item recommendation path table 20 is shown in reverse chronological order and comprising the information discussed above, the present invention is not limited to any order or structure of the media item (1) recommendation path table 20, and/or the amount or type of information included in the media item (1) recommendation path table 20.

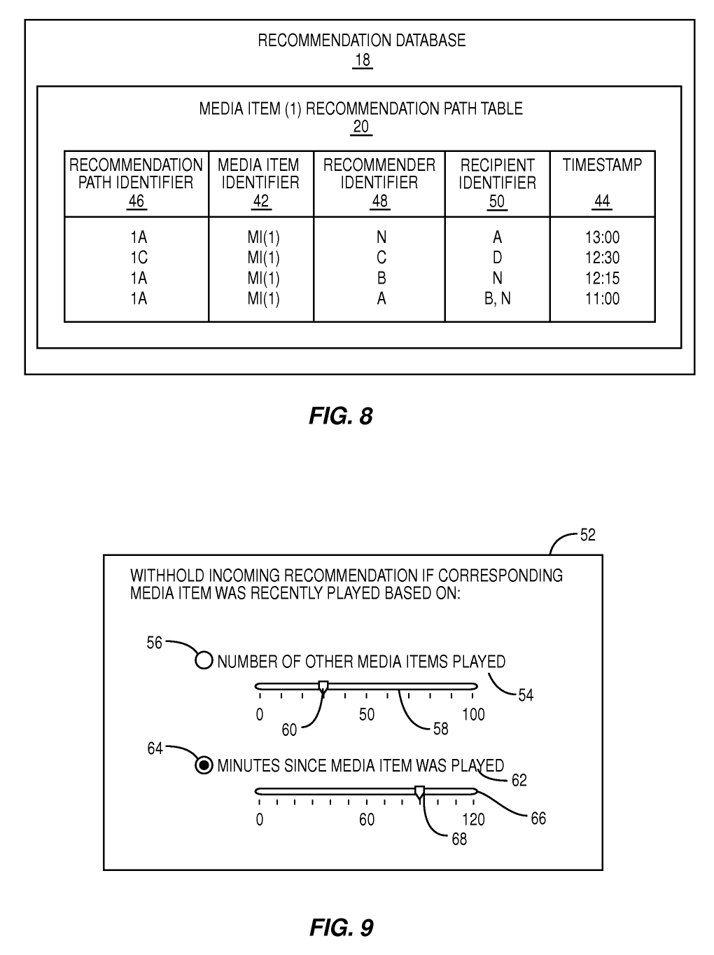

FIGS. 9-11 are exemplary graphical user interfaces (GUIs) illustrating three forms of an exemplary withholding incoming recommendation screen for allowing the user, as the recipient, to define the recommendation withholding activity information. The withholding incoming recommendation screen may be any type of presentation, including, but not limited to, a window or a slide, for example. As previously discussed, the occurrence of the recommendation withholding activity in the record of activity may determine whether the media item recommendation message 40 is sent to the recipient. FIGS. 9-11 illustrate how the user may control and manage the recommendation withholding activity by providing the conditions for the recommendation withholding activity to the central server 12 via the user device 26.

FIG. 9 is an exemplary GUI 52 illustrating a recently played recommendation withholding activity user screen. The GUI 52 may allow the user of the user device 26 to establish the recommendation withholding activity if the media item was played based on the number of other media items played by the user device 26, or the time that has elapsed since the media item was played, according to one embodiment of the present invention. The recently played recommendation withholding activity user screen may be any type of presentation, including, but not limited to, a window or slide, for example.

The GUI 52 may include a field for establishing a recommendation withholding activity based on ‘NUMBER OF OTHER MEDIA ITEMS PLAYED’ 54, which may include a media items played actuator 56 and a media items played selector 58. The media items played actuator 56 may be in the form of a radio button, and the media items played selector 58 may be in the form of a sliding bar with a media items played pointer 60. The media items played selector 58 conditions the recommendation withholding activity on the user playing a certain number of other media items since playing the media item. The GUI 52 may also include a field for providing a recommendation withholding activity based on ‘MINUTES SINCE MEDIA ITEM WAS PLAYED’ 62, which includes a time media item played actuator 64 and a time media item played selector 66. The time media item played actuator 64 may be in the form of a radio button, and the time media item played selector 66 may be in the form of a sliding bar with a time media item played pointer 68. The time media item played selector 66 conditions the recommendation withholding activity on a certain amount of time elapsing since the user of the user device 26 played the media item.

The user may establish the recommendation withholding activity by selecting the ‘NUMBER OF OTHER MEDIA ITEMS PLAYED’ 54 by actuating the media items played actuator 56 and selecting the number of media items played by setting the media items played pointer 60 on the media items played selector 58. Alternatively, the user may establish the recommendation withholding activity by selecting ‘MINUTES SINCE MEDIA ITEM WAS PLAYED’ 62 by actuating the time media item played actuator 64 and selecting the time that has elapsed since the media item was played by setting the time media item played pointer 68 on the time media item played selector 66.

FIG. 9 indicates that the recipient, the user of the user device 26, established the recommendation withholding activity based on ‘MINUTES SINCE MEDIA ITEM WAS PLAYED’ 62 by actuating the time media item played actuator 64 and selecting the time that has elapsed since the user of the user device 26 played the media item by setting the time media item played pointer 68 on the time media item played selector 66 to ‘90.’ In this case, the central server 12 may withhold from the recipient the media item recommendation message 40 for a media item until ninety minutes has elapsed since the last time the recipient played the media item. Although the GUI 52 includes radio buttons and sliding bars, it should be understood that the present invention is not limited to any particular type of actuator or selector. Additionally, it should be understood that the present invention is not limited to selectors providing any specific range of settings.

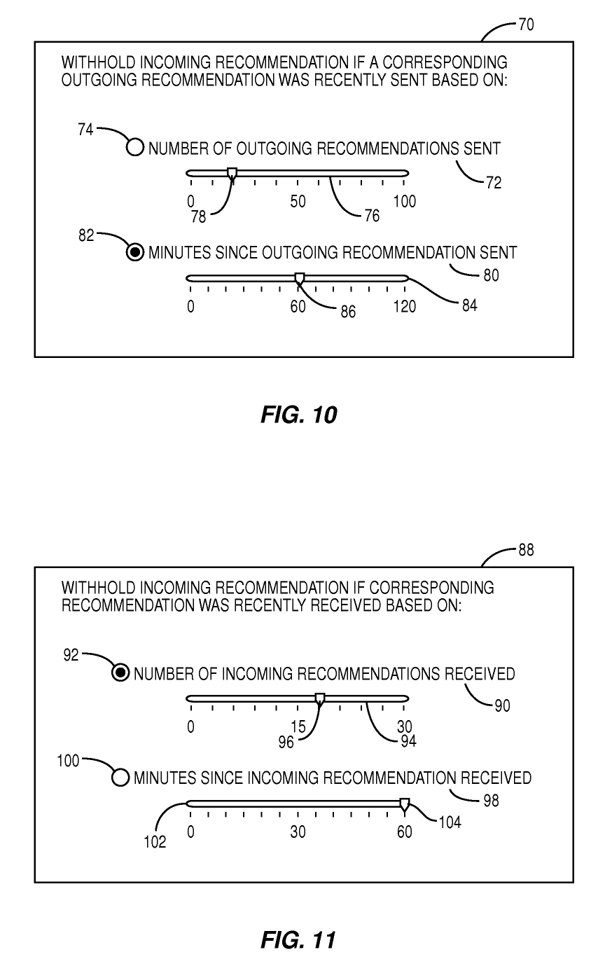

FIG. 10 is an exemplary GUI 70 illustrating a recently sent recommendation withholding activity screen. The GUI 70 may allow the user of the user device 26 to establish the recommendation withholding activity based on an outgoing recommendation of the media item from the user device 26, according to one embodiment of the present invention. In other words, the user of the user device 26 may establish the recommendation withholding activity for the central server 12 to withhold sending the media item recommendation message 40 to the user device 26 if a corresponding media item recommendation message 40 was sent by the user device 26. The recently sent recommendation withholding activity screen may be any type of presentation, including, but not limited to, a window or slide, for example.

The GUI 70 may include a field for establishing a recommendation withholding activity based on ‘NUMBER OF OUTGOING RECOMMENDATIONS SENT’ 72, which may include an outgoing recommendations sent actuator 74 and an outgoing recommendations sent selector 76. The outgoing recommendations sent actuator 74 may be in the form of a radio button, and the outgoing recommendations sent selector 76 may be in the form of a sliding bar with an outgoing recommendations sent pointer 78. The outgoing recommendations sent selector 76 conditions the recommendation withholding activity on the user of the user device 26 recommending a certain number of other media items. The GUI 70 also may include a field for providing a recommendation withholding activity based on ‘MINUTES SINCE OUTGOING RECOMMENDATION SENT’ 80, which may include a time outgoing recommendation sent actuator 82 and a time outgoing recommendation sent selector 84. The time outgoing recommendation sent actuator 82 may be in the form of a radio button, and the time outgoing recommendation sent selector 84 may be in the form of a sliding bar with a time outgoing recommendation sent pointer 86. The time outgoing recommendation sent selector 84 conditions the recommendation withholding activity on a certain amount of time elapsing since the user of the user device 26 recommended the media item.

The user may select the recommendation withholding activity by selecting ‘NUMBER OF OUTGOING RECOMMENDATIONS SENT’ 72 by actuating the outgoing recommendations sent actuator 74 and establishing the number of outgoing recommendations sent by setting the outgoing recommendations sent pointer 78 on the outgoing recommendations sent selector 76. Alternatively, the user may select the recommendation withholding activity condition by selecting ‘MINUTES SINCE OUTGOING RECOMMENDATION SENT’ 80 by actuating the time outgoing recommendation sent actuator 82 and establishing the time that has elapsed since the outgoing recommendation was sent by setting the time outgoing recommendation sent pointer 86 on the time outgoing recommendation sent selector 84.

FIG. 10 indicates that the recipient, the user of the user device 26, established the recommendation withholding activity based on ‘MINUTES SINCE OUTGOING RECOMMENDATION SENT’ 80 by actuating the time outgoing recommendation sent actuator 82 and selecting the time that has elapsed since the outgoing recommendation was sent by setting the time outgoing recommendation sent pointer 86 on the time outgoing recommendation sent selector 84 to ‘60.’ In this case, the central server 12 may withhold from the recipient the media item recommendation message 40 for a media item until sixty minutes has elapsed since the last time the recipient recommended the media item. Although the GUI 70 includes radio buttons 74, 82 and sliding bars 76, 84, it should be understood that the present invention is not limited to any particular type of actuator or selector. Additionally, it should be understood that the present invention is not limited to selectors providing any specific range of settings.

FIG. 11 is an exemplary GUI 88 illustrating a recently received recommendation withholding activity screen. The GUI 88 may allow the user of the user device 26 to establish the recommendation withholding activity based on an incoming recommendation of the media item to the user device 26, according to one embodiment of the present invention. In other words, the user of the user device 26 may establish the recommendation withholding activity for the central server 12 to withhold sending the media item recommendation message 40 to the user device 26 if a corresponding media item recommendation message 40 was recently received by the user device 26. The recently received recommendation withholding activity screen may be any type of presentation, including, but not limited to, a window or slide, for example.

The GUI 88 may include a field for establishing a recommendation withholding activity based on ‘NUMBER OF INCOMING RECOMMENDATIONS RECIEVED’ 90, which may include an incoming recommendations received actuator 92 and an incoming recommendations received selector 94. The incoming recommendations received actuator 92 may be in the form of a radio button, and the incoming recommendations received selector 94 may be in the form of a sliding bar with an incoming recommendations received pointer 96. The incoming recommendations received selector 94 conditions the recommendation withholding activity on the user of user device 26 receiving a certain number of recommendations for other media items. The GUI 88 also may include a field for providing a recommendation withholding activity based on ‘MINUTES SINCE INCOMING RECOMMENDATION RECEIVED’ 98, which includes a time incoming recommendation received actuator 100 and a time incoming recommendation received selector 102. The time incoming recommendation received actuator 100 may be in the form of a radio button, and the time incoming recommendation received selector 102 may be in the form of a sliding bar with a time incoming recommendation received pointer 104. The time incoming recommendation received selector 102 conditions the recommendation withholding activity on a certain amount of time elapsing since the user of user device 26 received the media item recommendation message 40.

The user may establish the recommendation withholding activity based on ‘NUMBER OF INCOMING RECOMMENDATIONS RECIEVED’ 90 by actuating the incoming recommendations received actuator 92 and selecting the number of incoming recommendations received by setting the incoming recommendations received pointer 96 on the incoming recommendations received selector 94. Alternatively, the user may select the recommendation withholding activity based on ‘MINUTES SINCE INCOMING RECOMMENDATION RECEIVED’ 98 by actuating the time incoming recommendation received actuator 100 and selecting the time that has elapsed since the incoming recommendation was received by setting the time incoming recommendation received pointer 104 on the time incoming recommendation received selector 102.

FIG. 11 indicates that the user of the user device 26 actuated the incoming recommendations received actuator 92 and selected the number of incoming recommendations received by setting the incoming recommendations received pointer 96 on the incoming recommendations received selector 94 to ‘18.’ In this case, the central server 12 may withhold from the recipient the media item recommendation message 40 for the media item if the recipient has received eighteen or fewer recommendations for other media items since the recipient last received a recommendation for the media item. Although the GUI 88 includes radio buttons 92,100 and sliding bars 94,102, it should be understood that the present invention is not limited to any particular type of actuator or selector. Additionally, it should be understood that the present invention is not limited to selectors providing any specific range of settings.

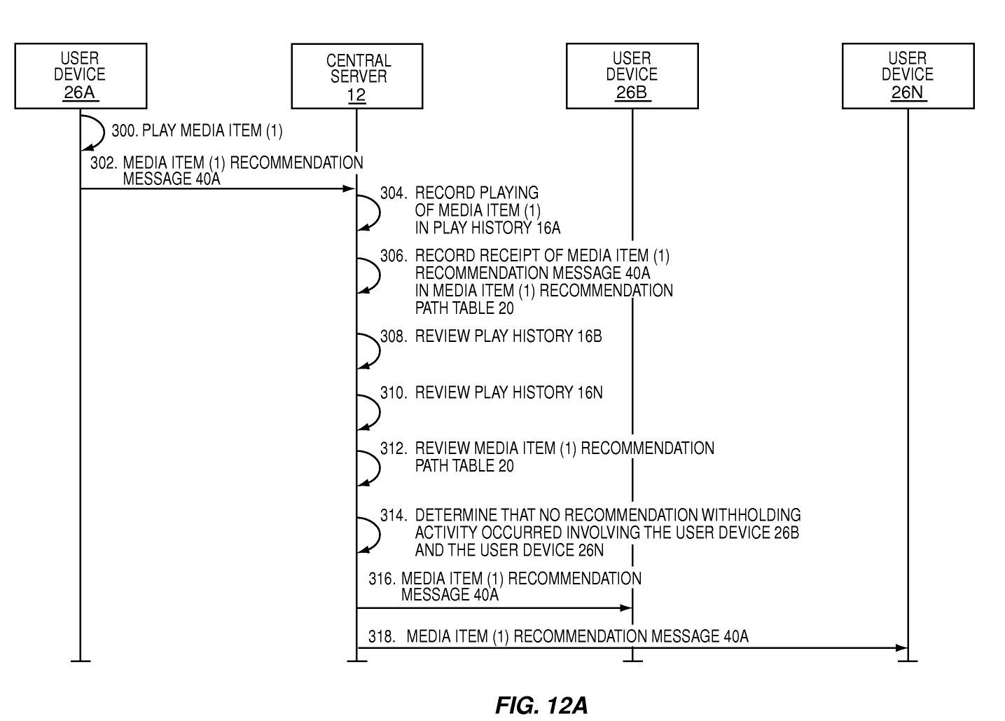

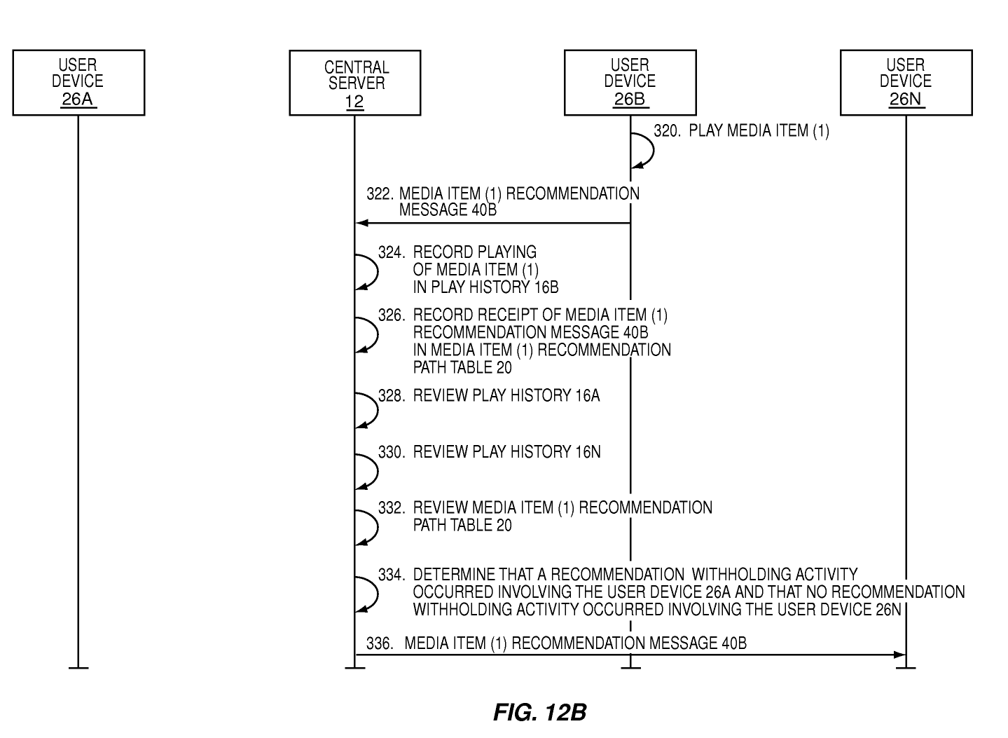

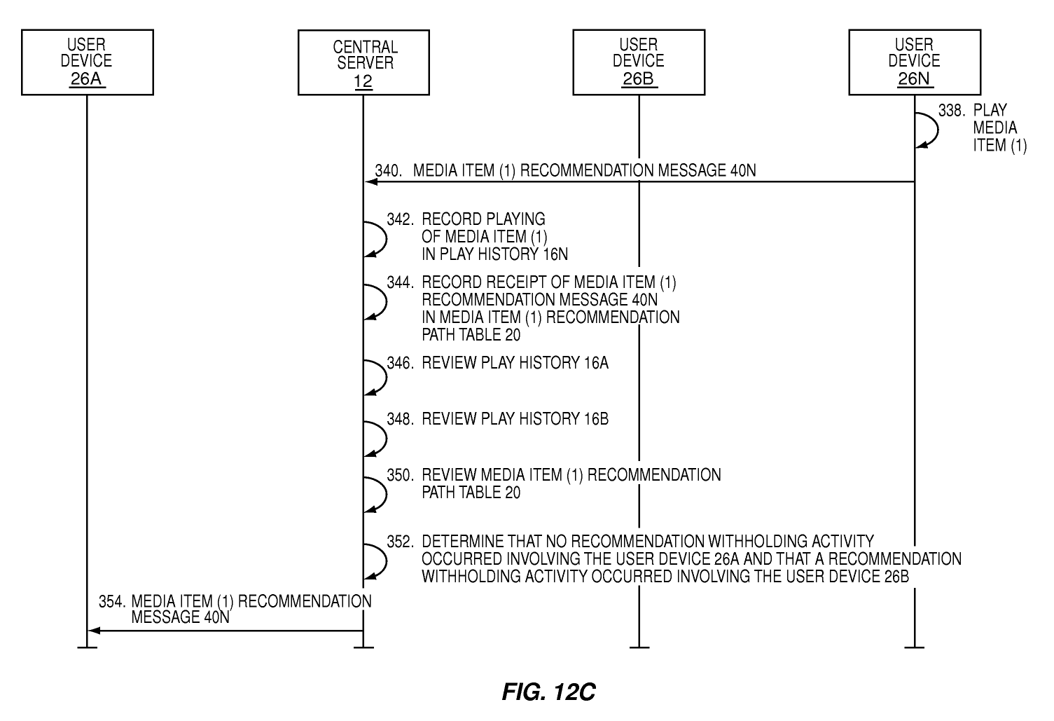

To further discuss the determination whether to send or withhold the media item recommendation message 40 based on a recommendation withholding activity, FIGS. 12A, 12B, and 12C illustrate exemplary communication flow diagrams between the central server 12 and the user devices 26A, 26B, 26N. FIGS. 12A, 12B, and 12C describe and discuss how the media item recommendation system 10 reduces the repetitive receipt of a media item recommendation message 40 when the media item recommendation message 40 is sent and received by multiple user devices 26, according to one embodiment of the present invention. It is assumed that the users of the user devices 26A, 26B, 26N have already provided the recommendation withholding activity information to the central server 12. Additionally, the activity illustrated in FIGS. 12A, 12B, and 12C coordinates with the above discussion of FIGS. 5-8 with respect to the play history 16A, the play history 16B, the play history 16N, respectively, and the media item (1) recommendation path table 20.

FIG. 12A shows that the user device 26A plays the media item (1) (step 300). The user device 26A then generates and sends the media item (1) recommendation message 40A to the central server 12 (step 302). The central server 12 records that the user device 26A played the media item (1) in the play history 16A (step 304) and records the receipt of the media item (1) recommendation message 40A from the user device 26A in the media item (1) recommendation path table 20 (step 306). The central server 12 then reviews the record of activity, which includes reviewing the play history 16B (step 308) and the play history 16N (step 310) to determine whether any recommendation withholding activity provided by information from the user of the user device 26B and whether any recommendation withholding activity provided by information from the user of the user device 26N occurred. Similarly, the central server 12 may also review the record of activity by reviewing the media item (1) recommendation path table 20 to determine whether any recommendation withholding activity provided by the information from the user of the user device 26B and whether any recommendation withholding activity provided by the information from the user of the user device 26N occurred (step 312).

The central server 12 determines from the review of the record of activity that no recommendation withholding activity occurred involving the user device 26B and the user device 26N (step 314). The central server 12 then sends the media item (1) recommendation message 40A to the user device 26B (step 316) and the user device 26N (step 318).

FIG. 12B shows that the user device 26B plays the media item (1) (step 320). The user device 26B then generates and sends the media item (1) recommendation message 40B to the central server 12 (step 322). The central server 12 records that the user device 26B played the media item (1) in the play history 16B (step 324) and records the receipt of the media item (1) recommendation message 40B from the user device 26B in the media item (1) recommendation path table 20 (step 326). The central server 12 then reviews the record of activity, which includes reviewing the play history 16A (step 328) and the play history 16N (step 330) to determine whether any recommendation withholding activity provided by information from the user of the user device 26A and whether any recommendation withholding activity provided by the information from the user of the user device 26N occurred. Similarly, the central server 12 may also review the record of activity by reviewing the media item (1) recommendation path table 20 to determine whether any recommendation withholding activity provided by the information from the user of the user device 26A and whether any recommendation withholding activity provided by the information from the user of the user device 26N occurred (step 332).

The central server 12 determines from the review of the record of activity that a recommendation withholding activity occurred involving the user device 26A, but that no recommendation withholding activity occurred involving the user device 26N (step 334). The central server 12 then sends the media item (1) recommendation message 40B to the user device 26N (step 336). Notably, the central server 12 does not send the media item (1) recommendation message 40B to the user device 26A.

FIG. 12C shows that the user device 26N plays the media item (1) (step 338). The user device 26N then generates and sends the media item (1) recommendation message 40N to the central server 12 (step 340). The central server 12 records that the user device 26N played the media item (1) in the play history 16N (step 342) and records the receipt of the media item (1) recommendation message 40N from the user device 26N in the media item (1) recommendation path table 20 (step 344). The central server 12 then reviews the record of activity, which includes reviewing the play history 16A (step 346) and the play history 16B (step 348) to determine whether any recommendation withholding activity provided by the information from the user of the user device 26A and whether any recommendation withholding activity provided by the information from the user of the user device 26B occurred. Similarly, the central server 12 may also review the record of activity by reviewing the media item (1) recommendation path table 20 to determine whether any recommendation withholding activity provided by the information from the user of the user device 26A and whether any recommendation withholding activity provided by the information from the user of the user device 26B occurred (step 350).

The central server 12 determines from the review of the record of activity that no recommendation withholding activity occurred involving the user device 26A, but that a recommendation withholding activity occurred involving the user device 26B (step 352). The central server 12 then sends the media item (1) recommendation message 40N to the user device 26A (step 354). Notably, the central server 12 does not send the media item (1) recommendation message 40N to the user device 26B.

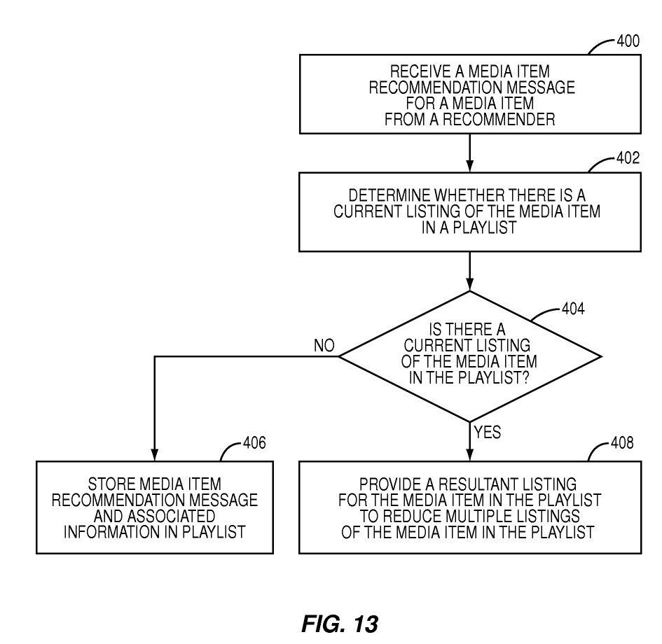

As discussed above, reducing the repetitive reception of a media item recommendation may be effected, additionally and/or alternatively, by reducing the generation and transmission of implicit media item recommendation messages 40. Implicit media item recommendation messages 40 may be automatically generated and transmitted as a result of the user device 26 playing the media item. The user device 26 may automatically play the media item based on the order in which the media item is listed in the playlist 34. However, if the media item is listed multiple times in the playlist 34, the media item may be played multiple times based on each time the media item is listed in the playlist 34. Thus, the present invention can also include systems and methods to reduce and/or prevent the multiple listings of a media item in the playlist 34 even if the generation and transmission of media item recommendation messages 40 are not monitored and/or reduced. Also, both systems and methods may be used to reduce and/or prevent the multiple listings of a media item in the playlist 34. In this regard, FIGS. 13-15 discuss such a system and method by example.

FIG. 13 is a flow chart illustrating a process for reducing the multiple listing of a media item in a playlist 34 according to one embodiment of the present invention. In this embodiment, the process may be performed by the user device 26. However, it should be understood that other devices and/or components of the media item recommendation system 10 may perform such process. Accordingly, the present invention is not limited to the user device 26 performing the process illustrated and described in FIG. 13. A media item recommendation message 40 is received and a determination is made whether there is a current listing of the media item in the playlist 34. Based upon whether there is a current listing, a resultant listing of the media item may be provided. The resultant listing is a listing of the media item in the playlist 34 that may be provided that reduces and/or prevents duplication in the playlist 34. In this manner, multiple listings of the media item in the playlist 34 may be reduced and/or prevented.

The process starts with the user device 26 receiving the media item recommendation message 40 for a media item from a recommender (step 400). The playlist 34 is then reviewed to determine whether there is a current listing of the media item in the playlist 34 (step 402). Information associated with the media item may also be listed in the playlist 34. The information may include, but not be limited to, the criteria discussed above, the identity of the recommender, the recommendation score, and the time the media item recommendation message 40 was received. A decision may then be made based on whether there is a current listing of the media item in the playlist 34 (step 404). If there is no current listing of the media item in the playlist 34, the media item recommendation and associated information, including, but not limited to, the identity of the recommender, the recommendation score, and the time of receipt of the media item recommendation message 40, may be stored in the playlist 34 (step 406). This is because adding the media item to the playlist 34 will not result in duplicative entries. However, if there is a current listing of the media item in the playlist 34, a resultant listing of the media item in the playlist 34 may be provided (step 408). As discussed above, a resultant listing is a listing of the media item in the playlist 34 that reduces and/or prevents duplication in the playlist 34. There are several methods of providing a resultant listing. Some are discussed by example below.

For example, if the current listing is based on a recommendation previously made by the recommender, the media item recommendation may be disregarded. This may prevent the recommender's playlist 34 from including media items resulting from previous recommendations to a user that are then forwarded back to the recommender, such as by a result of an automatic recommendation system based on play and/or usage. Because the current listing is based on a recommendation from the recommender of the media item recommendation message 40, the media item recommendation message may not include any new or additional information, and, therefore, the information associated with the media item may be redundant. In addition to the information being redundant, the redundant information could include a recommendation score that may inappropriately affect the media item score in the playlist 34. In such a case, the resultant listing in the playlist 34 would comprise the current listing without inclusion and/or adjustment of information in the playlist 34 based on the received media item recommendation.

Disregarding a media item recommendation may be an effective method of reducing and/or avoiding multiple listings of a media item in a playlist 34, but also may have the effect of disregarding information in the received media item that may be useful for other processing. This processing could include the time of receipt of the media item recommendation message 40, the storing of any presence information, and/or annotation that may be associated with the media item recommendation message 40. Thus, in an alternative embodiment, the resultant listing may be provided such that the information in the media item recommendation replaces the information in the current listing. The current listing may be based on a recommendation for the media item received a considerable amount of time in the past. As such, the information in the current listing may be old enough that, in effect, the information in the current listing may be stale and may have very little or no value.

Further, providing the resultant listing may comprise removing all information in the current listing if the media item is removed from the playlist 34. The playlist 34 may automatically remove media items for the playlist 34 due to certain conditions or criteria. One such exemplary condition may be the number of media items to be listed in the playlist 34. One such criteria may be genre, for example. The genre preferences of a recipient may have changed such that recommendations for media items in that genre are not scored as high as previously. Over time, the media items in that genre may start moving to the bottom of the playlist 34. If the media item recommendation message 40 is for a media item in that genre, a resultant listing may be outside of the allowed number of listings condition, particularly in view of other media item recommendation messages 40 received at about the same time for media items of a more preferred genre.

Another method of reducing and/or avoiding multiple listings of a media item in the playlist 34 may comprise merging information in the media item recommendation message 40 with information in the current listing in the playlist 34. Merging the information associated with the media item recommendation message 40 with the information currently listed in the playlist 34 may be performed in various ways. For example, the resultant listing in the playlist 34 may comprise updating the current listing to reflect the time of receiving the media item recommendation message 40.

In another example, merging the information to provide the resultant listing may be accomplished using an algorithm. The algorithm may be applied to the recommendation score in the media item recommendation message 40. The recommendation score may be based on various criteria and weighting applied to the criteria. The criteria may comprise title, author, date of release, genre, the number of times the media item was played, and the number of times the media item was recommended, for example. An example of a method and system for scoring or rating media items is described in co-pending U.S. patent application Ser. No. 11/484,130, entitled “P2P NETWORK FOR PROVIDING REAL TIME MEDIA RECOMMENDATIONS,” filed Jul. 11, 2006, which was incorporated herein by reference in its entirety above. Another example of a method and system for scoring or rating media items is described in co-pending U.S. patent application Ser. No. 11/695,327, entitled “RATING MEDIA ITEM RECOMMENDATIONS USING RECOMMENDATION PATHS AND/OR MEDIA ITEM USAGE,” filed Apr. 2, 2007, which is hereby incorporated herein by reference in its entirety.

Different algorithms may be used to compute a merged score based on the following:
b. a highest recommendation score from all of the media item recommendation messages 40 received;
c. a median recommendation score calculated from all of the media item recommendation messages 40 received;
d. an average recommendation score calculated from all of the media item recommendation messages 40 received;
e. a recommendation score from the first media item recommendation message 40 received;
f. a recommendation score from the last media item recommendation message 40 received; or
g. the highest recommendation score increased by a merit amount.

The merit amount may be included to take into account the reception of multiple recommendation scores of certain values to provide a merged score more representative of the media item being recommended than may result from using one of the other algorithms. For example, averaging three equal recommendation scores may not result in a merged score that accurately reflects the popularity of the media item.

Accordingly, in one embodiment, if there are three or more recommendation scores to be merged, and the recommendation scores are all equal or a majority of the recommendation scores are above a midrange value, then the merged score will be a score based on the highest recommendation score received increased by a predetermined merit amount, but not to exceed an absolute maximum which may be allowed. The midrange value may be defined as the highest recommendation score plus the lowest recommendation score divided by 2 ((max. score+min. score)/2). The predetermined amount may be any amount or value including, but not limited to, a percentage, such as ten percent (10%) of the highest recommendation score, for example. The predetermined amount may be selected by the user or may be a default value. For example, if three recommendation scores of 80, 80, and 20 are received, the midrange value may be calculated as (80+20)/2=50. Because a majority of the three received recommendation scores are above the midrange value of 50, the highest recommendation score of 80 may be increased by 10%, or 8, for a merged score of 88.

In this manner, multiple listings of the same media item and redundant information from media item recommendation messages 40 are not included in the playlist 34, but new and/or updated information in the media item recommendation message 40 may be included in the playlist 34. The above examples are not intended to be inclusive of all the ways to merge the associated information of the media item recommendation message 40 in a playlist 34 and, accordingly, the present invention is not limited to the above examples.

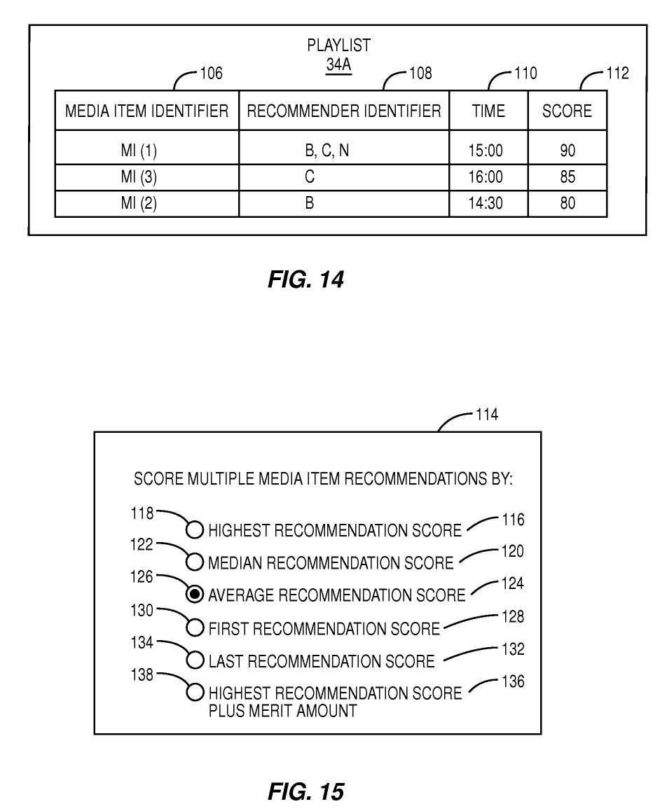

FIG. 14 illustrates an exemplary playlist 34 in the form of the playlist 34A on the user device 26A, according to one embodiment of the present invention. The playlist 34A shows the resultant listings of the media items and the associated information from media item recommendation messages 40 received by the user device 26A, and also illustrates how multiple media item recommendation messages 40 may be merged in the playlist 34.

FIG. 14 shows information for multiple media items based on the following media item recommendation messages 40 received by the user device 26A:

| Media Item Identifier | Recommender Identifier | Time | Score |
|---|---|---|---|
| MI(1) | B | 11:00 | 87 |
| MI(1) | N | 13:00 | 90 |
| MI(2) | B | 14:30 | 80 |
| MI(1) | C | 15:00 | 93 |
| MI(3) | C | 15:30 | 85 |
| MI(3) | C | 16:00 | 85 |

The above table shows that the user device 26A received three media item (1) recommendation messages 40 ‘MI(1),’ one each from the user B, the user N, and the user C. The table also shows that the user device 26A received one media item (2) recommendation message 40 ‘MI(2)’ from the user B and two media item (3) recommendation messages 40 ‘MI(3)’ from the user C.

FIG. 14 shows four columns, including a media item identifier column 106, a recommender identifier column 108, a time column 110, and a score column 112. Instead of listing each of the received media item recommendation messages 40 and the associated information in the playlist 34A, the information is merged for multiple media item recommendation messages 40. For example, the media item identifier column 106 lists the three media items that are recommended, MI(1), MI(2), and MI(3). Only one resultant listing for each of the media items is provided in the playlist 34A. The recommender identifier column 108 lists the recommender identifier for the recommenders of each of the media items. The recommender identifier column 108 indicates that the media item (1) was recommended by recommender ‘B,’ the recommender ‘C,’ and the recommender ‘N.’ The media item (2) was recommended by the recommender ‘B,’ and the media item (3) was recommended by the recommender ‘C.’ Only a single resultant listing of the media item (3) is included in the playlist 34A even though the recommender ‘C’ recommended the media item (3) twice.

The time column 110 shows only the time of the last received recommendation for that media item. The score column 112 shows the merged score of the media item. The user device 26A received three media item recommendations for media item (1) from recommenders ‘B,’‘C,’ and ‘N.’ The user of the user device 26A elected the algorithm that averages the recommendation scores of the received media item (1) recommendation messages 40 to compute the merged score listed in the playlist 34A. The merged score is shown in the score column 112 for the media item (1) as ‘90,’ which is the average of the three scores received for the media item (1). The playlist 34A lists the media items in the order of their merged scores, with the highest merged score first, which is ‘90’ for media item (1), descending to the lowest merged score, which is ‘80’ for media item (2).

FIG. 15 is an exemplary GUI 114 illustrating an exemplary score multiple media item recommendations screen for allowing the user to elect the manner in which to compute the merged score from multiple media item recommendation messages 40 for listing in the playlist 34. The score multiple media item recommendations screen may be any type of presentation, including, but not limited to, a window or a slide, for example.

Fields for six different algorithms for computing the merged score from multiple media item recommendation messages 40 are shown. Each of the fields include a selector associated with that field which may be in the form of a radio button. The user may select: ‘HIGHEST RECOMMENDATION SCORE’ 116 by actuating a highest score selector 118; ‘MEDIAN RECOMMENDATION SCORE’ 120 by actuating a median score selector 122; ‘AVERAGE RECOMMENDATION SCORE’ 124 by actuating an average score selector 126; ‘FIRST RECOMMENDATION SCORE’ 128 by actuating a first score selector 130; ‘LAST RECOMMENDATION SCORE’ 132 by actuating a last score selector 134; and ‘HIGHEST RECOMMENDATION SCORE PLUS MERIT AMOUNT’ 136 by actuating a highest recommendation score plus merit amount selector 138. If the ‘HIGHEST RECOMMENDATION SCORE PLUS MERIT AMOUNT’ 136 is selected, the merged score may be higher than the highest recommendation score to provide a merged score more representative of the media item being recommended. FIG. 15 shows that the user selected ‘AVERAGE RECOMMENDATION SCORE’ 124 and actuated the average score selector 126. Although the GUI 114 includes radio buttons as selectors 118, 122, 126, 130, 134, 138, it should be understood that the present invention is not limited to any particular type of selector or actuator.

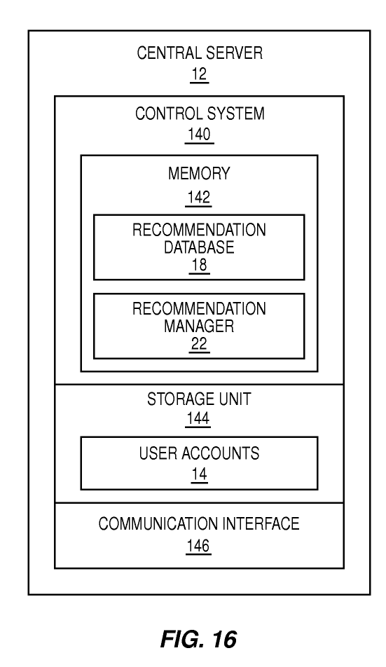

FIG. 16 is a block diagram illustrating more detail regarding the exemplary components that may be provided by the central server 12 of FIG. 1 to perform the present invention. In general, the central server 12 may be processor or microprocessor-based, and may also include a control system 140 having associated memory 142. The recommendation database 18 and the recommendation manager 22 may be at least partially implemented in software and stored in the memory 142. The central server 12 may also include a storage unit 144 operating to store the user accounts 14. The storage unit 144 may also store the recommendation database 18 (FIG. 1). The storage unit 144 may be any number of digital storage devices such as, for example, one or more hard-disc drives, one or more memory cards, Random Access Memory (RAM), one or more external digital storage devices, or the like. The user accounts 14 may alternatively be stored in the memory 142. A communication interface 146 may include a network interface allowing the central server 12 to be communicably coupled to the network 24 (FIG. 1).

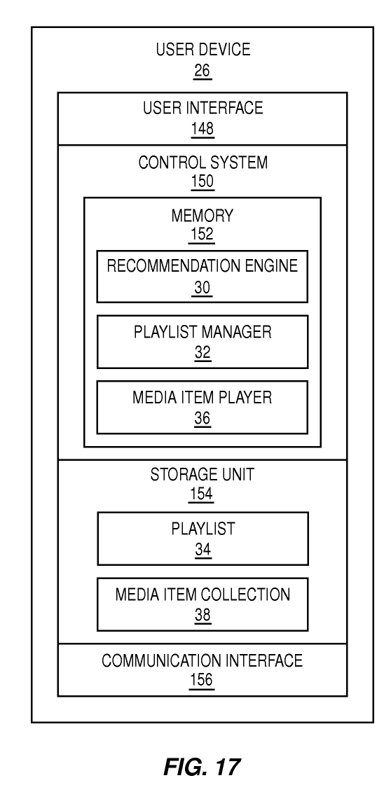

FIG. 17 is a block diagram illustrating more detail regarding the exemplary components that may be provided within the user device 26 of FIGS. 1 and 2 to provide the present invention. In general, the user device 26 may be processor or microprocessor-based and may also include a user interface 148, which may be used to interface with components such as a display, speakers, a user input device, and the like. The user device 26 also includes a control system 150 having associated memory 152. In this example, the recommendation engine 30, the playlist manager 32, and the media item player 36 are at least partially implemented in software and stored in the memory 152. The media item recommendation client application 28 (FIG. 2) may also be stored in the memory 152. The user device 26 also includes a storage unit 154 operating to store the playlist 34 and the media item collection 38. The storage unit 154 may be any number of digital storage devices such as, for example, one or more hard-disc drives, one or more memory cards, RAM, one or more external digital storage devices, or the like. The playlist 34 and the media item collection 38 may alternatively be stored in the memory 152. The user device 26 also includes a communication interface 156, which may include a network interface for communicatively coupling the user device 26 to the network 24 (FIG. 1).

The functionality of the present invention can be embodied in any computer-readable medium for use by or in connection with a computer-related system or method. In the context of the present invention, a computer-readable medium is an electronic, magnetic, optical, semiconductor, or other device or means that can transmit, contain, or store computer instructions, programs, or data for use by or in connection with a computer-related system or method.

Those skilled in the art will recognize improvements and modifications to the preferred embodiments of the present invention. All such improvements and modifications are considered within the scope of the concepts disclosed herein and the claims that follow.

What is claimed is:

1. A method for reducing the repetitive reception of a media item recommendation in a media item recommendation system, comprising the steps of:
receiving from a recommender, a media item recommendation for a media item intended for a recipient;
reviewing a record of activity of the media item; and
determining whether to send the media item recommendation to the recipient based on the record of activity.

2. The method of claim 1, wherein the record of activity comprises a play history of the recipient.

3. The method of claim 1, wherein the record of activity comprises a record of recommendations of the media item.

4. The method of claim 1, wherein the determining whether to send the media item recommendation to the recipient based on the record of activity comprises determining whether the record of activity includes a recommendation withholding activity.

5. The method of claim 4, further comprising the step of receiving the recommendation withholding activity from the recipient.

6. The method of claim 4, further comprising the step of sending the media item recommendation to the recipient if the record of activity does not include the recommendation withholding activity.

7. The method of claim 4, further comprising the step of withholding the media item recommendation from the recipient if the record of activity includes the recommendation withholding activity.

8. The method of claim 4, wherein the recommendation withholding activity comprises the recipient playing the media item.

9. The method of claim 8, wherein the recommendation withholding activity further comprises the recipient playing a certain number of other media items since the recipient playing the media item.

10. The method of claim 8, wherein the recommendation withholding activity further comprises a certain amount of time elapsing since the recipient playing the media item.

11. The method of claim 4, wherein the recommendation withholding activity comprises the recipient recommending the media item.

12. The method of claim 11, wherein the recommendation withholding activity further comprises the recipient recommending a certain number of other media items since the recipient recommending the media item.

13. The method of claim 11, wherein the recommendation withholding activity further comprises a certain amount of time elapsing since the recipient recommending the media item.

14. The method of claim 4, wherein the recommendation withholding activity comprises the recipient receiving a recommendation for the media item.

15. The method of claim 14, wherein the recommendation withholding activity further comprises the recipient receiving a certain number of recommendations for other media items since the recipient receiving the recommendation for the media item.

16. The method of claim 14, wherein the recommendation withholding activity further comprises a certain amount of time elapsing since the recipient receiving the recommendation for the media item.

17. A system for reducing the repetitive reception of a media item recommendation in a media item recommendation system, comprising:
a control system, wherein the control system is adapted to:
receive from a recommender a media item recommendation for a media item intended for a recipient;
review a record of activity of the media item; and
determine whether to send the media item recommendation to the recipient based on the record of activity.

18. The system of claim 17, wherein the record of activity comprises a play history of the recipient.

19. The system of claim 17, wherein the record of activity comprises a record of recommendations of the media item.

20. The system of claim 17, wherein the control system adapted to determine whether to send the media item recommendation to the recipient based on the record of activity comprises the control system adapted to determine whether the record of activity includes a recommendation withholding activity.

21. The system of claim 20, wherein the control system is further adapted to receive the recommendation withholding activity from the recipient.

22. The system of claim 20, wherein the control system is further adapted to send the media item recommendation to the recipient if the record of activity does not include the recommendation withholding activity.

23. The system of claim 20, wherein the control system is further adapted to withhold the media item recommendation from the recipient if the record of activity includes the recommendation withholding activity.

24. The system of claim 20, wherein the recommendation withholding activity comprises the recipient playing the media item.

25. The system of claim 24, wherein the recommendation withholding activity further comprises the recipient playing a number of other media items since the recipient playing the media item.

26. The system of claim 24, wherein the recommendation withholding activity further comprises a certain amount of time elapsing since the recipient playing the media item.

27. The system of claim 20, wherein the recommendation withholding activity comprises the recipient recommending the media item.

28. The system of claim 27, wherein the recommendation withholding activity further comprises the recipient recommending a certain number of other media items since the recipient recommending the media item.

29. The system of claim 27, wherein the recommendation withholding activity further comprises a certain amount of time elapsing since the recipient recommending the media item.

30. The system of claim 20, wherein the recommendation withholding activity comprises the recipient receiving a recommendation for the media item.

31. The system of claim 30, wherein the recommendation withholding activity further comprises the recipient receiving a certain number of recommendations for other media items since the recipient receiving the recommendation for the media item.

32. The system of claim 30, wherein the recommendation withholding activity further comprises a certain amount of time elapsing since the recipient receiving the recommendation for the media item.

33. A computer-readable medium comprising instructions for instructing a computer to:
receive from a recommender a media item recommendation for a media item intended for a recipient;
review a record of activity of the media item; and
determine whether to send the media item recommendation to the recipient based on the record of activity.

34. The computer-readable medium of claim 33, wherein the record of activity comprises a play history of the recipient.

35. The computer-readable medium of claim 33, wherein the record of activity comprises a record of recommendations of the media item.

36. The computer-readable medium of claim 33, wherein the instruction to determine whether to send the media item recommendation to the recipient based on the record of activity comprises an instruction to determine whether the record of activity includes a recommendation withholding activity.

37. The computer-readable medium of claim 36, further comprising instructions for instructing a computer to receive the recommendation withholding activity from the recipient.

38. The computer-readable medium of claim 36, further comprising instructions for instructing a computer to send the media item recommendation to the recipient if the record of activity does not include the recommendation withholding activity.

39. The computer-readable medium of claim 36, further comprising instructions for instructing a computer to withhold the media item recommendation from the recipient if the record of activity includes the recommendation withholding activity.

40. A user interface generated by an application executing on a processor, comprising:
a withhold incoming recommendation screen, comprising:
a field, wherein the field identifies a recommendation withholding activity; and
a selector associated with the field, wherein the selector conditions the recommendation withholding activity, and wherein a media item recommendation message for a media item is withheld from a recipient based on the recommendation withholding activity.

41. The user interface of claim 40, wherein the recommendation withholding activity comprises the recipient playing the media item.

42. The user interface of claim 41, wherein the selector conditions the recommendation withholding activity on the recipient playing a certain number of other media items played since the recipient playing the media item.

43. The user interface of claim 41, wherein the selector conditions the recommendation withholding activity on a certain amount of time elapsing since the recipient playing the media item.

44. The user interface of claim 40, wherein the recommendation withholding activity comprises the recipient recommending the media item.

45. The user interface of claim 44, wherein the selector conditions the recommendation withholding activity on the recipient recommending a certain number of other media items since the recipient recommending the media item.

46. The user interface of claim 44, wherein the selector conditions the recommendation withholding activity on a certain amount of time elapsing since the recipient recommending the media item.

47. The user interface of claim 40, wherein the recommendation withholding activity comprises the recipient receiving a recommendation for the media item.

48. The user interface of claim 47, wherein the selector conditions the recommendation withholding activity on the recipient receiving a certain number of media item recommendations for other media items since receiving the recommendation for the media item.

49. The user interface of claim 47, wherein the selector conditions the recommendation withholding activity on a certain amount of time elapsing since the recipient receiving the recommendation for the media item.
